(19) United States
(12) Patent Application Publication
(10) Pub. No.: US 2010/0110188 A1
(43) Pub. Date: May 6, 2010

(54) INVERTED VEHICLE FRONT VIEWING SYSTEM

(76) Inventor: Robert R. Brester, New Berlin, WI (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/262,946

(22) Filed: Oct. 31, 2008

(51) Int. Cl. H04N 7/18

(52) U.S. Cl. 348/148; 348/E07.085

(57) ABSTRACT

A vehicle front viewing system useful in viewing an area in front of a vehicle has a camera and a support arm. The camera has a field of view. The support arm supports the camera and is attachable to the vehicle so that a field of view of the camera encompasses the area in front of the vehicle when the support arm is attached to the vehicle.

### TECHNICAL FIELD

The technical field of the material described herein relates to systems that are arranged to view an area in the front of a vehicle. Such a viewing system may include, for example, a convex mirror and/or camera that views the area in front of the vehicle.

### BACKGROUND

Mirrors are typically used on a vehicle to provide the operator with a field of view behind and along both sides of the vehicle so that the operator may more safely operate the vehicle. However, in some instances, it is also desirable to provide the operator with a field of view of the area in front of the vehicle. For example, school bus drivers can have trouble seeing children, particularly shorter children, crossing in close proximity to the front of the school bus. In order to avoid accidents when children cross in close proximity to the front of the school bus, it is known to mount mirrors in front of the bus with a backward and downward field of view. Thus, the school bus operator is made aware of any children who otherwise might not be in the operator's field of view.

However, the use of such a mirror poses significant problems. For example, if the mirror is planar with little or no magnification, then the field of view is limited. On the other hand, if the mirror is convex with a positive magnification, the field of view is greater than in the case of a planar mirror, but the objects in the image provided by the convex mirror are smaller and at a significant distance from the driver's eye. Thus, objects in the field of view are difficult to discern or recognize. Also, a mirror provides very limited visibility when little sunlight is available such as at night, dawn, and dusk. Thus, a driver has difficulty seeing persons or objects in front of the vehicle during such conditions. Moreover, mirrors are large, which increases wind resistance and vibration. Accordingly, mirrors adversely affect fuel efficiency and vehicle ride.

The present invention overcomes one or more of these or other disadvantages.

### BRIEF DESCRIPTION OF THE DRAWINGS

Features and advantages of the vehicle front viewing system described below will become more apparent from the detailed description when taken in conjunction with the drawings in which:

FIG. 1 is a top view of a vehicle front viewing system that includes a support arm and a camera mount;

FIG. 2 is a left side view of the vehicle front viewing system of FIG. 1;

FIG. 3 is a front view of the vehicle front viewing system of FIG. 1;

FIG. 4 is a bottom view of the vehicle front viewing system of FIG. 1;

FIG. 5 is a side view of the vehicle front viewing system of FIG. 1 showing the camera from the vantage point of a driver of a vehicle to which the vehicle front viewing system is mounted;

FIG. 6 is a rear view of the vehicle front viewing system of FIG. 1; and,

FIG. 7 shows the vehicle front viewing system of the above figures mounted to a vehicle.

### DETAILED DESCRIPTION

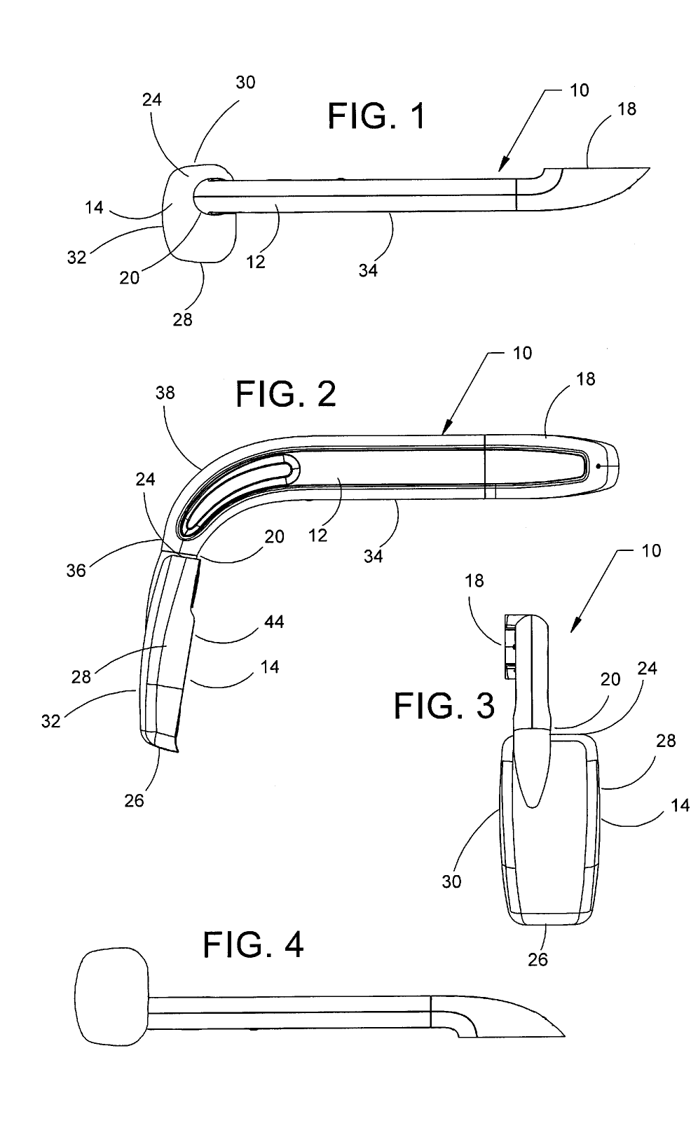

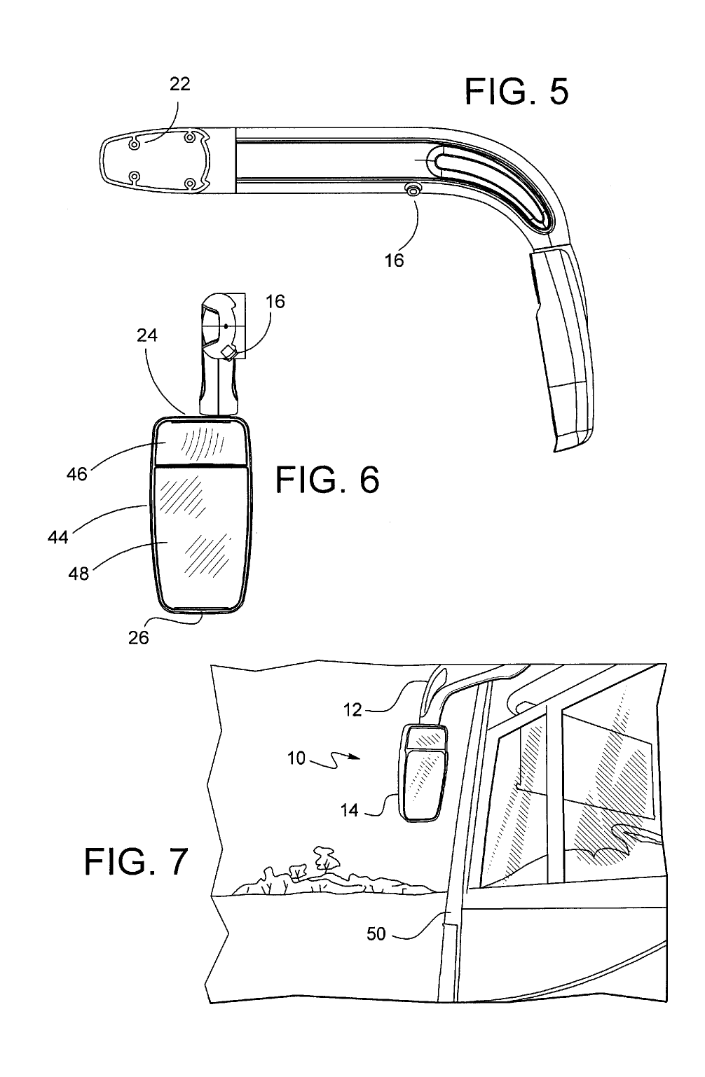

As shown in FIGS. 1, 2, 3, 4, and 5, a vehicle front viewing system 10 includes a support arm 12 and a camera 16. The support arm 12, for example, may include a mirror housing 14. The support arm 12 has first and second ends 18 and 20. The first end 18 attaches the support arm 12 to a vehicle, and the second end 20 includes the mirror housing 14.

The first end 18, for example, has fastener receiving holes 22 that receive fasteners such as screws that extend through a panel or other structure of the vehicle and into the first end 18 of the support arm 12 to secure the support arm 12 to the vehicle. However, the support arm 12 may be otherwise secured to the vehicle.

The mirror housing 14 may be formed as an integral part of the support arm 12. However, the support arm 12 and the mirror housing 14 may be attached to one another such as by fasteners. Alternatively, the support arm 12 and the mirror housing 14 may be otherwise secured to one another.

The mirror housing 14, as shown in the drawings, has a top 24 that faces upwardly when the vehicle front viewing system 10 is mounted to a vehicle, a bottom 26 that faces downwardly when the vehicle front viewing system 10 is mounted to a vehicle, left and right sides 28 and 30 extending between the top 24 and the bottom 26, and a back 32 formed integrally with the top 24, the bottom 26, and the left and right sides 28 and 30. The top 24, the bottom 26, the left and right sides 28 and 30, and the back 32 form a well or recess (not shown). However, the mirror housing 14 may be otherwise formed such as by separate top, bottom, sides, and back suitably secured to one another, or the mirror housing 14 may be formed as a bracket or other structure.

The camera 16 is suitably secured to the support arm 12 at a position so that its field of view is the front of the vehicle when the support arm 12 is affixed to the vehicle. For example, a nut or other fastening device may be used to fasten the camera 16 within a recess of the support arm 12. Alternatively, the camera 16 may have a housing that is arranged to be threaded into the support arm 12. Other fastening arrangements are possible. An electrical wire from the camera 16 runs through the interior of the support arm 12 to a display that is suitable mounted to the vehicle for viewing by the vehicle operator.

The camera 16 is fixedly mounted to the support arm 12 so that the camera 16 has a fixed viewing angle with respect to the vehicle to which it is mounted. Alternatively, the camera 16 could be mounted to the support arm 12 so that the camera 16 may be rotated on the support arm 12 in order to provide a variable viewing angle with respect to the vehicle to which it is mounted.

As can be seen from FIG. 2, the support arm 12 has a horizontal arm portion 34, a vertical arm portion 36, and a curved arm portion 38 that joins the horizontal arm portion 34 and the vertical arm portion 36. The vertical arm portion 36 includes the mirror housing 14. The camera 16 is mounted to the horizontal arm portion 34. However, the camera 16 could instead be mounted to either the vertical arm portion 36 that includes the mirror housing 14 (such that the camera 16, for example, can be supported by the mirror housing 14) or the curved arm portion 38.

The mirror housing 14 also a mirror 44. The mirror 44, for example, may have an upper mirror portion 46 and a lower mirror portion 48. Alternatively, the mirror 44 may have more than two portions. For example, the mirror 44 may be a triple glass system.

The upper mirror portion 46 and the lower mirror portion 48 may be independently moved with respect to the mirror housing 14 either by manual operation or by motor operation so that the fields of view of the upper mirror portion 46 and the lower mirror portion 48 may be independently adjusted.

Alternatively or additionally, the upper mirror portion 46 and the lower mirror portion 48 may have the same magnification or different magnifications. For example, both the upper mirror portion 46 and the lower mirror portion 48 may be planar so that they each have a magnification of one. As another example, one of the upper mirror portion 46 and the lower mirror portion 48 may be convex so as to have a magnification greater than one, and the other of the upper mirror portion 46 and the lower mirror portion 48 may be planar so as to have a magnification of one. As still another example, both of the upper mirror portion 46 and the lower mirror portion 48 may be convex so as to have a magnification greater than one. Other examples are possible.

In this manner, the mirror 44 provides a field of view to the vehicle operator that extends alongside and behind the vehicle, and the camera 16 provides a field of view to the vehicle operator of the area in front of the vehicle. The field of view of the area in front of the vehicle may encompass the front bumper of the vehicle and/or the area ahead of the front bumper of the vehicle. In this manner, the vehicle operator can see if there is anything or anyone in front of the vehicle before the vehicle is put into forward operation.

FIG. 6 shows the vehicle front viewing system 10 mounted to a vehicle 50. As can be seen in FIG. 6, the support arm 12 is fastened to a side of the vehicle 50 so that camera 16 and the mirror 44 are to the side but in front of the vehicle 50. Thus, the mirror housing 14 is mounted to the vehicle 50 such that the top 24 of the mirror housing 14 abuts the second end 20 of the support arm 12 and is directed in an upwardly direction with respect to the vehicle 50 and such that the bottom 26 of the mirror housing 14 is opposite to and below the top 24 and is directed in an downwardly direction with respect to the vehicle 50. Further, the dimension of the mirror housing 14 between the top 24 and the bottom 26 is vertical and is longer than the dimension of the mirror housing 14 between left and right sides 28 and 30 which is horizontal. Accordingly, the vehicle front viewing system 10 has an inverted appearance.

The camera 16, for example, may have or include infrared capability so that the front of the vehicle may be viewed even in diminished light conditions. Accordingly, the camera 16 may comprise an infrared light camera such as an infrared LED camera, a visible light camera, or a composite of an infrared light camera and visible light camera. Moreover, the camera 16 may be small so that it has little mass, fitting snugly in the support arm 12 to offer little or no wind resistance and cause little or no vibration.

Certain modifications of the present invention have been discussed above. Other modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A vehicle front viewing system useful in viewing an area in front of a vehicle comprising:
a support arm having first and second ends, wherein the first end of the support arm is attachable to the vehicle, wherein the second end of the support arm is distal from the first end, wherein the second end includes a mirror having a top and a bottom, wherein the top is directed upwardly when the support arm is attached to the vehicle, wherein the bottom of the mirror is directed downwardly when the support arm is attached to the vehicle, and wherein the support arm is configured such that the second end of the support arm extends in front of the vehicle when the first end of the support arm is attached to the vehicle;
a camera mounted to the support arm so that the camera has a field of view that encompasses the area in front of the vehicle when the first end of the support arm is attached to the vehicle.

2. The vehicle front viewing system of claim 1 wherein the mirror comprises a rear facing mirror.

3. The vehicle front viewing system of claim 1 wherein the support arm has a horizontal arm portion and a vertical arm portion, wherein the vertical arm portion includes the mirror, and wherein the camera is mounted to the horizontal arm portion.

4. The vehicle front viewing system of claim 1 wherein the camera is fixedly mounted to the support arm.

5. The vehicle front viewing system of claim 1 wherein the camera comprises an infrared camera.

6. The vehicle front viewing system of claim 1 wherein the first end of the support arm is attachable to a side of the vehicle such that the support arm extends alongside and in front of the vehicle.

7. A method of providing viewing of an area in front of a vehicle comprising:
securing a first fastener to a first end of a support arm and to the vehicle so that a second end of the support arm is distal from the first end and extends in front of the vehicle, wherein the support arm includes a camera so that a field of view of the camera encompasses the area in front of the vehicle when the first end of the support arm is fastened to the vehicle, wherein the second end of the support arm includes a mirror that extends downwardly when the support arm is fastened to the vehicle; and,
securing a second fastener to the first end of the support arm and to the vehicle.

8. The method of claim 7 wherein the mirror comprises a rear facing mirror.

9. The method of claim 7 wherein the support arm has a horizontal arm portion and a vertical arm portion, wherein the camera is mounted to the horizontal arm portion, and wherein the vertical arm portion includes the mirror.

10. The method of claim 7 wherein the camera is fixedly secured to the support arm.

11. The method of claim 7 wherein the camera comprises an infrared camera.

12. The method of claim 7 wherein the securing of a first fastener and a second fastener to a first end of a support arm and to the vehicle comprises fastening the first end of the support arm to a side of the vehicle such that the support arm extends alongside and in front of the vehicle.

13. A vehicle front viewing system useful in viewing an area in front of a vehicle comprising:
a camera having a field of view; and,
a support arm supporting the camera and attachable to the vehicle so that the support arm extends alongside and to the front of the vehicle, so that the camera is mounted in front of the vehicle, and so that the field of view of the camera encompasses the area in front of the vehicle when the support arm is attached to the vehicle.

14. The vehicle front viewing system of claim 13 wherein the support arm comprises first and second ends, wherein the first end of the support arm is attachable to the vehicle, wherein the second end of the support arm is distal from the first end, and wherein the camera is mounted between the first and second ends of the support arm.

15. The vehicle front viewing system of claim 14 wherein the support arm further includes a mirror.

16. The vehicle front viewing system of claim 15 wherein the mirror comprises a rear facing mirror.

17. The vehicle front viewing system of claim 16 wherein the support arm comprises a horizontal arm portion and a vertical arm portion, wherein the vertical arm portion extends below the horizontal arm portion when the support arm is mounted to the vehicle, and wherein the vertical arm portion includes the mirror.

18. The vehicle front viewing system of claim 13 wherein the camera is fixedly attached to the support arm.

19. The vehicle front viewing system of claim 13 wherein the camera comprises an infrared camera.
